(19) United States
(12) Patent Application Publication
(10) Pub. No.: US 2002/0096032 A1
(43) Pub. Date: Jul. 25, 2002

(54) Cutter with monoblock blade carrier with securement and release of the blade by pressure

(76) Inventors: Jean-Claude Peyrot, Bordeaux (FR); Marc Michiels, Salies De Bearn (FR)

Correspondence Address: YOUNG & THOMPSON, 745 SOUTH 23RD STREET 2ND FLOOR, ARLINGTON, VA, 22202

(21) Appl. No.: 09/992,006

(22) Filed: Nov. 26, 2001

(30) Foreign Application Priority Data
Nov. 24, 2000 (FR) 00 15202

(51) Int. Cl. B26B 3/00

(52) U.S. Cl. 83/698.11; 30/331; 30/339

(57) ABSTRACT

The object of the invention is a cutter with a monoblock blade carrier with securement and release of the blade by pressure, characterized in that said blade carrier (1) is made by molding from a semi-rigid plastic material and comprises two substantially flat shells (1a, 1b) folded facing each other, connected by a thin bridge (2) and defining between them a recess for the reception of a blade (3) open at least on its sides, one of the portions (1a) comprising on its internal surface a projection (10) adapted to penetrate a hole (5) in the blade (3) so as to trap it in said recess (8, 8a) and being, adjacent this latter, deformable by pressure (P) so that, by a lever effect, said projection (10) moves away from the opposite surface of the other shell (1b), thereby permitting the free passage of the blade (3) outside its recess (8, 8a).

Application to cutters.

The present invention relates to a cutter with a monoblock blade carrier whose blade can be fixed in place or freed for changing, by simple pressure.

The object of the invention is to provide a simple blade carrying structure, which will be effective and will not require any dismounting for the emplacement or the changing of a blade.

To this end, the invention has for its object a cutter with a monoblock blade carrier for securement and release of the blade by pressure, characterized in that said blade carrier is made by molding a semi-rigid plastic material and comprises two substantially flat shells folded into facing arrangement with each other, connected by a thin bridge and defining between them a recess for receiving an open blade at least on one side, one of the portions comprising on its internal surface a projection adapted to penetrate a hole in the blade so as to trap it in said recess and being, adjacent this latter, deformable by pressure so as to undergo, by a lever effect, the removal of said projection from the opposite surface of the other shell, thereby permitting the free passage of the blade from its recess.

According to one embodiment, said projection is provided adjacent the free end of a tongue forming all or a portion of one of the two shells of the blade carrier, said tongue being adapted to swing about a bearing point provided on the second shell facing the central region of the tongue, during pressure exerted on this latter, between said bearing point and the foot of the tongue, in the direction of said second shell.

Such an arrangement is particularly simple and inexpensive to make because it comprises a single molded piece which, by simple deformation by pressure of a thumb for example, permits emplacement or removal of a thin conventional blade, and by release of said pressure, returns to the normal use position of the cutter, the blade being correctly and firmly held and retained trapped in its recess and leaving nothing projecting outside other than the portion carrying the cutting edge.

No associated member, fixed or movable, is accordingly necessary to control the unlocking of the blade.

Other characteristics and advantages will become apparent from the description which follows, of one embodiment of a cutter according to the invention, which description is given only by way of example and with respect to the accompanying drawing, in which:

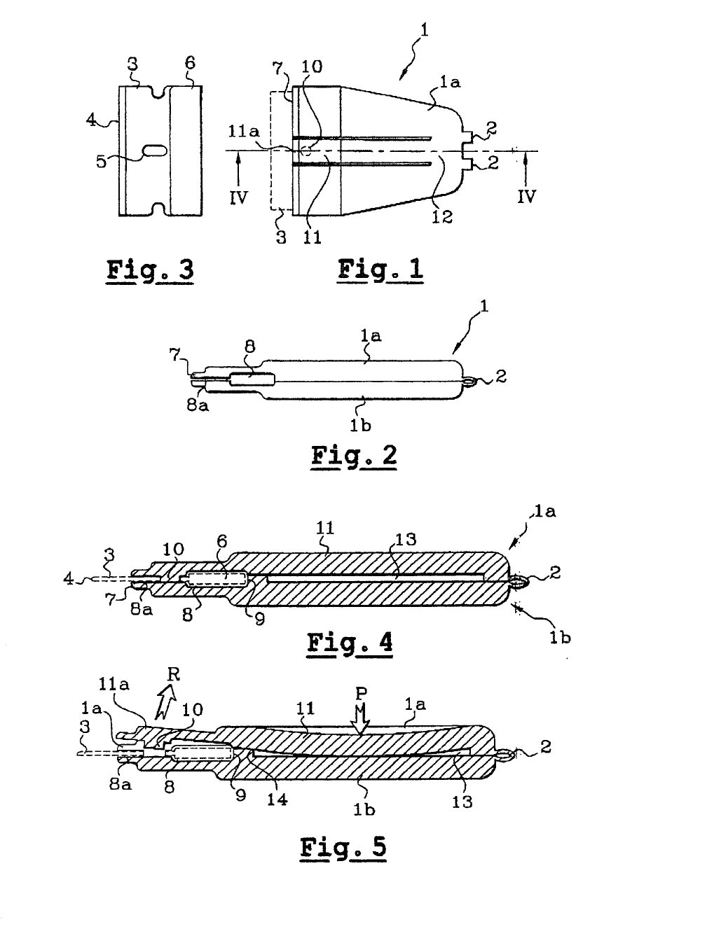

FIG. 1 is a top plan view of a cutter according to the invention,

FIG. 2 is a side elevational view of the cutter of FIG. 1,

FIG. 3 is a top plan view of a type of conventional blade usable with the cutter,

FIG. 4 is an enlarged cross-sectional view on the line IV-IV of the cutter of FIG. 1, and

FIG. 5 shows the cutter of FIG. 4 in the opening position of the recess of the blade for its retraction.

The cutter shown in the drawings is constituted by a single piece of semi-rigid injection molded plastic material, comprising two shells 1a and 1b connected by a hinge constituted by two thin bridges 2. Upon demolding, the shells 1a, 1b are substantially in the same plane and side by side and are then folded against each other, the articulation taking place in line with the connection hinge 2, and being maintained in this position, like a clamshell, by any suitable means (not shown) such as welding or snapping by lugs into receiving holes.

The shells 1a, 1b thus folded together form a blade carrier 1 receiving a conventional rectangular blade 3 of the type shown in FIG. 3.

This blade 3 has a cutting edge 4, an oblong central hole 5 and its other edge is gripped in a metallic holder 6.

The blade carrier 1 comprises, opposite the axis of the hinge 2, a parallel edge 7 from which the portion carrying the cutting edge 4 of the blade 3 protrudes.

The blade carrier 1 thus forms a cutter of reduced dimensions which can be held between the thumb, the index finger and the middle finger to be used as a scraper to clean automobile windshields.

The blade 3 is trapped between the shells 1a, 1b in a recess 8 defined in the region adjacent the edge 7.

This recess 8 comprises a portion adapted to receive the holder 6 of the blade, connected to the front edge 7 of the cutter by a slot 8a, delimited between the two shells 1a, 1b and of a thickness very slightly greater than that of the blade 3.

The recess 8 and the slot 8a open on both lateral sides of the cutter as can be seen in FIG. 2, thereby permitting sliding the blade 3 laterally of the cutter, from one side to the other.

In the correct position of the blade 3 in the cutter, the holder 6 abuts against a shoulder 9 provided in the lower shell 1b (FIG. 3), whilst into the hole 5 extends, into contact with the facing wall of the shell 1b, a centering-holding lug 10, formed on the upper shell 1a.

More precisely, the lug 10 is carried by a rectangular tongue 11 cut out in the medial zone (FIG. 3) of the upper shell 1a, from the free edge 7.

The tongue 11, in its portion located between the shoulder 9 and the foot 12 of the tongue, faces a hollow 13 provided in the lower shell 1b. Adjacent the shoulder 9 is thus defined a bearing point 14 such that a pressure P (FIG. 4) exerted for example with the thumb on the portion of the tongue 11 between the bearing point 14 and the foot 12 of the tongue in the hollow 13 causes, by a lever effect while bearing on the point 14, the rising in the direction R of the nose 11a of the tongue and hence the spacing from the shell 1b of the lug 10 to unblock the blade 3.

The tongue 11 alone is deformed by this pressure, so that on opposite sides of the tongue, the region of the shell 1a adjacent the edge 7 remains in place, thereby preserving the slot 8a. Thus, the blade 3 remains held between the shells 1a, 1b and is not driven by the nose 11a of the tongue.

It is thus normally freed by the lug 10 and can be extracted from its recess, laterally, from either side of the cutter, for changing the blade, for example.

Relaxing the pressure P, the device recovers resiliently, because of the nature of the plastic material used, to the position (3a) for locking the new blade 3 by penetration of the lug 10 into the hole 5.

The principle of control of the spacing of the lug 10 from its locking position is by a lever action of the type in which the bearing point (14) is located between the point of application of the force (P) that controls, and the point of application of the resulting force (R).

It is evident that this principle can be used according to different modifications without thereby departing from the scope of the invention.

Thus the shapes and dimensions of the portion (tongue 11) arranged to act as a swinging gate can vary over a wide range, said tongue being if desired constituted by one (la) of the two shells bent against each other.

Similarly, the recess (8, 8a) that receives the blade 3 is suitable for the type of blade which can vary, this recess being moreover shaped in the non-deformable shell (1b) and if desired provided with locking means for the movement of the blade perpendicular to its plane.

The hinge (2) connecting the two shells 1a, 1b and whose interest is evident because it permits the production by a single mold of a monoblock blade carrier by simple folding the two shells against each other, can of course be made of another material with one or several elements.

1. Cutter with a monoblock blade carrier with securement and release of the blade by pressure, characterized in that said blade carrier (1) is made by molding of a semi-rigid plastic material and comprises two substantially flat shells (1a, 1b) folded against each other, connected by a thin bridge (2) and defining between them a recess for receiving a blade (3) open at least on its sides, one of the parts (1a) comprising on its internal surface a projection (10) adapted to penetrate into a hole (5) in the blade (3) so as to trap it within said recess (8, 8a) and being, adjacent this latter, deformable by pressure (P) such that, by a lever effect, said projection (10) moves away from the opposite surface of the other shell (1b), thereby permitting the free passage of the blade (3) outside its recess (8, 8a).

2. Cutter according to claim 1, characterized in that said projection (10) is provided adjacent the free end of a tongue (11) forming all or a portion of one (1a) of the two shells of the blade carrier (1), said tongue (11) being adapted to swing about a bearing point (14) provided on the second shell (1b) facing the central region of the tongue during pressure exerted on this latter, between said bearing point (14) and the foot (12) of the tongue (11), in the direction of said second shell (1b).

3. Cutter according to claim 1 or 2, characterized in that said recess (8, 8a) of the blade (3) is rectangular and open on three sides so as to insert the blade (3) laterally from one side or the other of the cutter.

4. Cutter according to claim 3, characterized in that a hollow (13) is provided between the lower shell (1b) and the tongue (11) so as to permit swinging of this latter during application of said pressure (P).
